(19) United States
(12) Patent Application Publication
(10) Pub. No.: US 2026/0290316 A1
(43) Pub. Date: Sep. 24, 2026

(54) TRAINING DEVICE, TRAINING METHOD, TRAINING PROGRAM, AND SPEECH SYNTHESIS DEVICE

(71) Applicant: NTT, Inc., Tokyo (JP)

(72) Inventors: Naoki MAKISHIMA, Musashino-shi, Tokyo (JP); Ryo MASUMURA, Musashino-shi, Tokyo (JP)

(73) Assignee: NTT, Inc., Tokyo (JP)

(21) Appl. No.: 18/873,774

(22) PCT Filed: Jun. 22, 2022
(86) PCT No.: PCT/JP2022/024985

§ 371 Date: Dec. 11, 2024

(51) Int. Cl. G10L 13/08

(52) U.S. Cl. CPC G10L 13/08

(57) ABSTRACT

A fourth training device generates data related to a synthesized speech from first embedded data representing a characteristic of an utterance of a speaker and first text data by using a speech synthesis model. The fourth training device generates second text data from data related to a synthesized speech by using the speech synthesis model. The fourth training device updates parameters of the speech synthesis model and parameters of the speech recognition model such that the first embedded data is similar to second embedded data representing a characteristic of an utterance of a synthesized speech, and the first text data is similar to the second text data.

### TECHNICAL FIELD

The present invention relates to a training device, a training method, a training program, and a speech synthesis device.

### BACKGROUND ART

Conventionally, a technique for performing collaborative learning of a speech recognition (automatic speech recognition (ASR)) model and a speech synthesis (text to speech (TTS)) model is known.

The speech recognition model is a model that outputs the utterance content using speech as an input. The speech synthesis model is a model that outputs a speech obtained by reading out text by a speaker of a reference speech using the text and the reference speech as inputs. The model is, for example, a neural network.

In a case where the speech recognition model and the speech synthesis model are separately trained, it is necessary that a large amount of pair data of speech and text is prepared, that is, a supervised condition is satisfied.

On the other hand, in a case where the collaborative learning of the speech recognition model and the speech synthesis model is performed, it is sufficient if a small amount of pair data of speech and text and data of only a large amount of text (hereinafter described as text data) are prepared. That is, in a case where the collaborative learning of the speech recognition model and the speech synthesis model is performed, it is sufficient if a semi-supervised condition is satisfied.

For example, Non Patent Literature 1 describes, as a method for performing collaborative learning, a method of forming a speech synthesis and speech recognition pipeline (TTS-ASR pipeline) and training the pipeline with a reconstruction error.

### CITATION LIST

### Non Patent Literature

Non Patent Literature 1: M. K. Baskar, L. Burget, S. Watanabe, R. F. Astudillo, and J. H. Cernocky, “Eat: Enhanced ASR-TTS for self-supervised speech recognition,” in Proc. ICASSP, 2021, pp. 6753-6757.

### SUMMARY OF INVENTION

### Technical Problem

However, the conventional technique has a problem in that a high-quality synthesized speech cannot be obtained in some cases.

For example, in a case where collaborative learning of a speech recognition model and a speech synthesis model is performed by the method described in Non Patent Literature 1, the speech synthesis model tends to output an unnatural speech that is easily recognized by the speech recognition model.

For example, in a case where a natural synthesized speech such as a human speech is demanded, an unnatural speech may not be recognized as a high-quality speech.

### Solution to Problem

In order to solve the above-described problem and achieve the object, a training device includes: a synthesis unit that generates data related to a synthesized speech from first embedded data representing a characteristic of a speaker and first text data by using a first model; a recognition unit that generates second text data from data related to the synthesized speech by using a second model; and an update unit that updates a parameter of the first model and a parameter of the second model such that the first embedded data is similar to second embedded data representing a characteristic of a speaker of the synthesized speech, and the first text data is similar to the second text data.

In order to solve the above-described problem and achieve the object, a speech synthesis device includes: a synthesis unit that generates data related to a synthesized speech from third embedded data representing a characteristic of an utterance of a speaker and a third text data by using a first model whose parameter has been updated by processing of generating data related to a synthesized speech from first embedded data representing a characteristic of an utterance of a speaker and first text data by using the first model, generating second text data from data related to the synthesized speech by using a second model, and updating the parameter of the first model and a parameter of the second model such that the first embedded data is similar to second embedded data representing a characteristic of an utterance of the synthesized speech, and the first text data is similar to the second text data.

### Advantageous Effects of Invention

According to the present invention, it is possible to obtain a high-quality synthesized speech.

### BRIEF DESCRIPTION OF DRAWINGS

FIG. 1 is a diagram describing an outline of training processing according to a first embodiment.

FIG. 2 is a diagram illustrating a configuration example of a training device.

FIG. 3 is a diagram describing processing contents of a first training device,

FIG. 4 is a diagram describing processing contents of a second training device.

FIG. 5 is a diagram describing processing contents of a third training device,

FIG. 6 is a diagram describing processing contents of a fourth training device.

FIG. 7 is a flowchart illustrating a flow of training processing according to the first embodiment.

FIG. 8 is a diagram describing processing contents of a speech recognition device.

FIG. 9 is a diagram describing processing contents of a speech synthesis device.

FIG. 10 is a diagram describing processing contents of a fourth training device according to a second embodiment.

FIG. 11 is a diagram describing processing contents of a fifth training device and a sixth training device according to a third embodiment.

FIG. 12 is a diagram illustrating experimental results.

FIG. 13 is a diagram illustrating an example of a computer that executes a training program.

### DESCRIPTION OF EMBODIMENTS

Hereinafter, embodiments of a training device, a training method, a training program, and a speech synthesis device according to the present application will be described in detail with reference to the drawings. Note that the present invention is not limited to the embodiments described below.

### First Embodiment

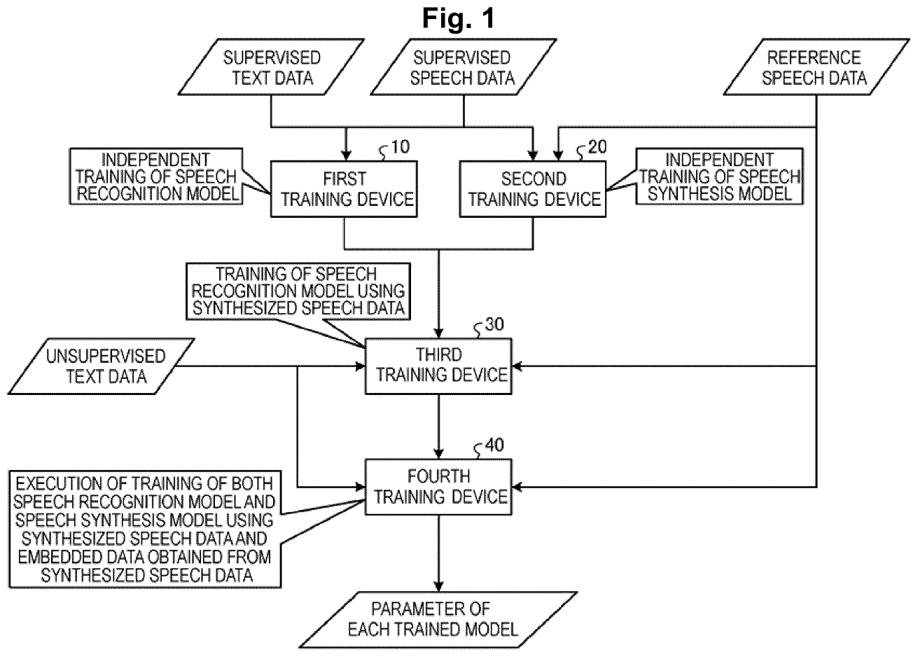

First, the outline of the first embodiment will be described with reference to FIG. 1. FIG. 1 is a diagram describing an outline of training processing according to the first embodiment.

As illustrated in FIG. 1, in the present embodiment, parameters of each trained model are output by a first training device 10, a second training device 20, a third training device 30, and a fourth training device 40. Note that, in FIG. 1, an outline of the entire training processing will be described. Details of processing in each training device will be described below.

The model described here includes a speech recognition model and a speech synthesis model. The speech recognition model and the speech synthesis model include different neural networks.

The speech recognition model is a model that outputs text data using speech data as an input. The speech data is a feature value of speech, and for example, it is desirable to output text data obtained by transcribing the speech indicated by the input speech data to the speech recognition model.

The speech synthesis model is a model that outputs a synthesized speech or synthesized speech data that is a feature value of synthesized speech by using text data and reference speech data as inputs. In the present embodiment, the speech synthesis model outputs synthesized speech data. In addition, it is assumed that the synthesized speech data can be appropriately converted into a synthesized speech.

The reference speech data is a feature value of speech of a single or a plurality of speakers. For example, the speech synthesis model is desired to generate a synthesized speech in which the speaker corresponding to the reference speech data reads out the text data.

Here, supervised speech data and supervised text data are paired data. For example, the supervised speech data is obtained by a human actually reading out supervised text data.

On the other hand, there may be no speech data to be paired with unsupervised text data. Therefore, it is easier to prepare a large amount of unsupervised text data than to prepare a large amount of speech data and supervised text data.

That is, in model training, an unsupervised condition can be more easily satisfied than a supervised condition.

In the present embodiment, machine learning using a sufficient amount of pair data of supervised speech data and supervised text data as training data is referred to as supervised learning. In addition, machine learning using a small amount of pair data and unsupervised text data as training data is referred to as semi-supervised learning. The semi-supervised learning includes a case where the training data does not include the pair data at all.

In the present embodiment, a part of the training processing is performed by supervised learning, and the other part is performed by semi-supervised learning.

As illustrated in FIG. 1, the first training device 10 receives inputs of the supervised speech data and the supervised text data, and independently trains the speech recognition model. In other words, the first training device 10 performs supervised learning regarding the speech recognition model. The first training device 10 outputs parameters of the trained speech recognition model.

The second training device 20 receives inputs of the supervised speech data, the supervised text data, and the reference speech data, and independently trains the speech synthesis model. In other words, the second training device 20 performs supervised learning regarding the speech synthesis model. The second training device 20 outputs parameters of the trained speech synthesis model.

The second training device 20 acquires embedded data from the reference speech data. The speech synthesis model uses the embedded data to adapt the synthesized speech data to the speaker.

The third training device 30 receives inputs of the parameters of the trained speech recognition model, the parameters of the trained speech synthesis model, the unsupervised text data, and the reference speech data. Then, the third training device 30 trains the speech recognition model using the synthesized speech data on the basis of the input data. Similarly to the second training device 20, the third training device 30 acquires embedded data from the reference speech data.

In the third training device 30, a small amount of pair data may be used together with the unsupervised text data. In other words, the third training device 30 performs semi-supervised learning regarding the speech synthesis model.

The third training device 30 obtains synthesized speech data by inputting the unsupervised text data and the reference speech data to the speech synthesis model constructed from the parameters of the trained speech synthesis model.

In addition, the third training device 30 further updates the parameters of the trained speech synthesis model. On the other hand, the third training device 30 does not update the parameters of the trained speech synthesis model.

Therefore, with the third training device 30, it is possible to prevent the speech synthesis model from outputting an unnatural speech that is easily recognized by the speech recognition model. Further, with the third training device 30, the recognition accuracy for the synthesized speech data by the speech recognition model can be improved.

The fourth training device 40 receives inputs of the parameters of the trained speech recognition model, the parameters of the trained speech synthesis model, the unsupervised text data, and the reference speech data. Then, the fourth training device 40 executes training of both the speech recognition model and the speech synthesis model using the recognition result (text data) of the synthesized speech data and the embedded data obtained from the synthesized speech on the basis of the input data.

In the fourth training device 40, a small amount of pair data may be used together with the unsupervised text data. In other words, the fourth training device 40 performs semi-supervised learning regarding both the speech recognition model and the speech synthesis model.

The fourth training device 40 obtains synthesized speech data by inputting the unsupervised text data and the reference speech data to the speech synthesis model constructed from the parameters of the trained speech synthesis model.

Further, the fourth training device 40 acquires embedded data from the synthesized speech data.

Then, the fourth training device 40 updates the parameters of both the speech synthesis model and the speech recognition model on the basis of the recognition result (text data) obtained by inputting the synthesized speech data to the speech recognition model constructed from the parameters of the trained speech recognition model and the embedded data acquired from the synthesized speech data.

As a result, with the fourth training device 40, it is possible to prevent the speech synthesis model from outputting an unnatural speech that is easily recognized by the speech recognition model. Further, with the fourth training device 40, the recognition accuracy for the synthesized speech by the speech recognition model can be improved.

In addition, with the third training device 30 and the fourth training device 40, it is possible to prevent the recognition accuracy of the speech recognition model from deteriorating due to over-adaptation of the synthesized speech data to the speech recognition model.

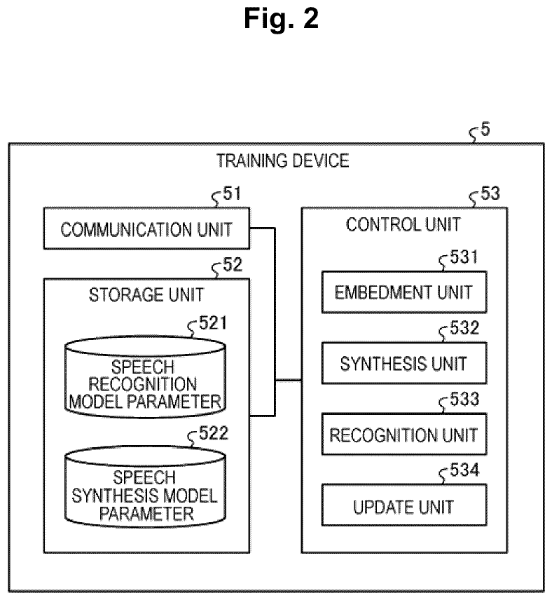

The first training device 10, the second training device 20, the third training device 30, and the fourth training device 40 in FIG. 1 may be achieved by different devices. On the other hand, the first training device 10, the second training device 20, the third training device 30, and the fourth training device 40 may be achieved by one training device illustrated in FIG. 2. FIG. 2 is a diagram illustrating a configuration example of the training device.

For example, the first training device 10, the second training device 20, the third training device 30, and the fourth training device 40 in FIG. 1 may be replaced with a first training step, a second training step, a third training step, and a fourth training step, respectively. In this case, a training device 5 illustrated in FIG. 2 executes the first training step, the second training step, the third training step, and the fourth training step.

As illustrated in FIG. 2, the training device 5 includes a communication unit 51, a storage unit 52, and a control unit 53.

The communication unit 51 performs data communication with another device. For example, the communication unit 51 is a network interface card (NIC). In addition, the communication unit 51 may be an interface for inputting and outputting data to and from an input device (for example, a mouse and a keyboard) and an output device (for example, a display).

The storage unit 52 is a storage device such as a hard disk drive (HDD), a solid state drive (SSD), or an optical disk. Note that the storage unit 52 may be a semiconductor memory capable of rewriting data, such as random access memory (RAM), flash memory, or non-volatile static random access memory (NVSRAM). The storage unit 52 stores an operating system (OS) and various programs executed by the training device 5.

The storage unit 52 stores a speech recognition model parameter 521 and a speech synthesis model parameter 522. The speech recognition model parameter 521 and the speech synthesis model parameter 522 are appropriately updated in each training step.

The control unit 53 controls the entire training device 5. The control unit 53 is achieved by, for example, an electronic circuit or an integrated circuit such as a central processing unit (CPU), a micro processing unit (MPU), or a graphics processing unit (GPU), an application specific integrated circuit (ASIC), or a field programmable gate array (FPGA).

In addition, the control unit 53 includes an internal memory for storing programs and control data defining various processing procedures, and executes each processing using the internal memory. In addition, the control unit 53 functions as various processing units when various programs operate. For example, the control unit 53 includes an embedment unit 531, a synthesis unit 532, a recognition unit 533, and an update unit 534.

The embedment unit 531 acquires embedded data from the speech data.

The synthesis unit 532 generates synthesized speech data from the text data and the embedded data. The synthesis unit 532 inputs the text data and the embedded data to the speech synthesis model and causes the speech synthesis model to output the synthesized speech data.

The recognition unit 533 recognizes the speech data. The recognition unit 533 inputs the speech data to the speech recognition model and causes the speech recognition model to output the text data.

The update unit 534 updates the parameters of the speech recognition model and the speech synthesis model. For example, the update unit 534 updates the parameters of each model so that an error function created on the basis of the output of at least one of the speech recognition model and the speech synthesis model is optimized.

Details of each training device (training step) illustrated in FIG. 1 will be described. In the following description, it is assumed that the embedment unit, the synthesis unit, the recognition unit, and the update unit can execute processing similar to those of the embedment unit 531, the synthesis unit 532, the recognition unit 533, and the update unit 534 of the training device 5 regardless of the attached signs.

However, the data input to each unit is different for each training device (training step). For example, the speech data input to the recognition unit may be supervised speech data, unsupervised speech data, or both supervised speech data and unsupervised speech data.

In addition, the update unit is common in each training device (training step) in that the parameters of the speech recognition model, the speech synthesis model, or both are updated, but error functions created for updating the parameters may be different from each other.

In addition, the parameters of the speech recognition model and the speech synthesis model are appropriately updated for each training device (training step).

As an example, in the present embodiment, by performing stepwise model optimization with each training device (training step), the objects of improving the quality of the synthesized speech, preventing over-adaptation of the synthesized speech, and improving the accuracy of speech recognition are achieved.

### [First Training Device]

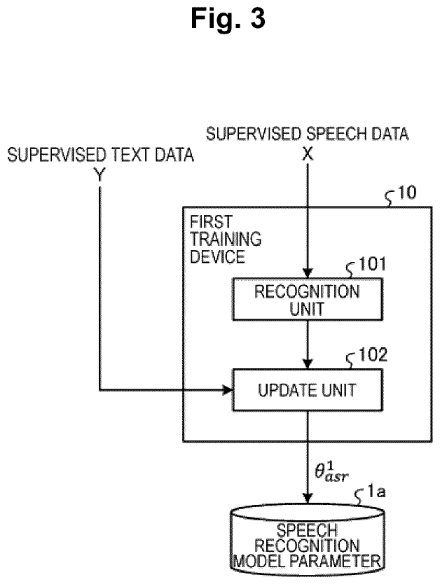

FIG. 3 is a diagram describing processing contents of the first training device. As illustrated in FIG. 3, the first training device 10 includes a recognition unit 101 and an update unit 102. The first training device 10 performs supervised learning of the speech recognition model.

Supervised speech data X and supervised text data Y are input to the first training device 10.

The supervised speech data X is expressed as (x₁, . . . , x_{T}). However, an element xₜ of the supervised speech data X is the feature value of a t-th frame among frames of a length T, and is data of a predetermined number of dimensions.

The feature value of the speech is, for example, a log Mel filterbank (log Mel filterbank coefficients (FBANK)). In addition, the feature value of the speech is not limited to the log Mel filterbank, and may be Mel frequency cepstral coefficient (MFCC), ΔMFCC (first-order differentiation of MFCC), ΔΔMFCC (second-order differentiation of MFCC), logarithmic power, Δlogarithmic power (first-order differentiation of logarithmic power), or the like.

The recognition unit 101 inputs the supervised speech data X to the speech recognition model and causes the speech recognition model to output text data y. The speech recognition model at this time point may be, for example, in an initial state in which an arbitrary parameter is set, or may be one in which training has been performed to some extent. The text data y can be said to be text data inferred by the speech recognition model. The text data y is expressed as (y₁, . . . , y_{L}). However, an element y₁ of the text data y is a 1-th token of the tokenized text. L is the length of the sequence of tokens. For example, the text is tokenized for each phoneme.

The update unit 102 updates the parameters of the speech recognition model so that the posterior probability of Formula (1) is maximized.

$$\begin{matrix}[ Math . 1 ] & \\ P ( y \vert X ; {Θ}_{asr} ) = {\prod }_{l} P ( {y}_{l} \vert {y}_{1 : l - 1} , X ; {Θ}_{asr} ) & ( 1 )\end{matrix}$$

Here, the speech recognition model of the present embodiment is assumed to be a transformer-type neural network including an encoder and a decoder (for example, see Reference Literature 1). Θₐₛᵣ is a parameter such as a weight and a bias of the neural network.

Reference Literature 1; L. Dong, S, Xu, and B. Xu, “Speech-transformer: A no-recurrence sequence-to-sequence model for speech recognition,” in Proc. ICASSP, 2018, pp. 5884-5888.

The posterior probability of Formula (1) is obtained by Formulae (2), (3), and (4).

$$\begin{matrix}[ Math . 2 ] & \\ H = TransformerEnc ( X ; {θ}_{asr}^{enc} ) & ( 2 )\end{matrix}$$

$$\begin{matrix}[ Math . 3 ] & \\ {c}_{l} = TransformerDec ( H , {y}_{1 : l - 1} ; {θ}_{asr}^{dec} ) & ( 3 )\end{matrix}$$

$$\begin{matrix}[ Math . 4 ] & \\ P ( {y}_{l} \vert {y}_{1 : l - 1} , X ; {Θ}_{asr} ) = softmax ( {c}_{l} ; {θ}_{asr}^{linear} ) [ {y}_{l} ] & ( 4 )\end{matrix}$$

However, TransformerEnc (⋅) is a portion corresponding to the encoder of the speech recognition model. However, the encoder includes a self-attention mechanism. θ^{enc}ₐₛᵣ is a parameter of the encoder of the speech recognition model.

In addition, TransformerDec (⋅) is a portion corresponding to the decoder of the speech recognition model. However, the decoder comprises an embedding layer and an attention mechanism between the encoder and the decoder. θ^{dec}ₐₛᵣ is a parameter of the decoder of the speech recognition model.

softmax (⋅) is a softmax layer having a linear transformation layer. θ^{linear}ₐₛᵣ is a parameter of the softmax layer.

[yₗ] is the probability corresponding to the element yₗ of the supervised text data Y. In training, the probability that the speech recognition model predicts yl as the next element from the sequence of elements from yₗ to yₗ₋₁ is maximized.

In addition, Θₐₛᵣ is a combination of θ^{enc}ₐₛᵣ, θ^{dec}ₐₛᵣ, and θ^{linear}ₐₛᵣ. The update unit 102 updates Θₐₛᵣ such that an error function (cross entropy) L_{CE} of Formula (5) is minimized. For example, the update unit 102 updates the parameter of the neural network by backpropagation.

$$\begin{matrix}[ Math . 5 ] & \\ {L}_{CE} = - \frac{1}{L} {\sum }_{l} log P ( {y}_{l} \vert {y}_{1 : l - 1} , X ; {Θ}_{asr} ) & ( 5 )\end{matrix}$$

The first training device 10 outputs the updated parameter as a speech recognition model parameter 1a.

### [Second Training Device]

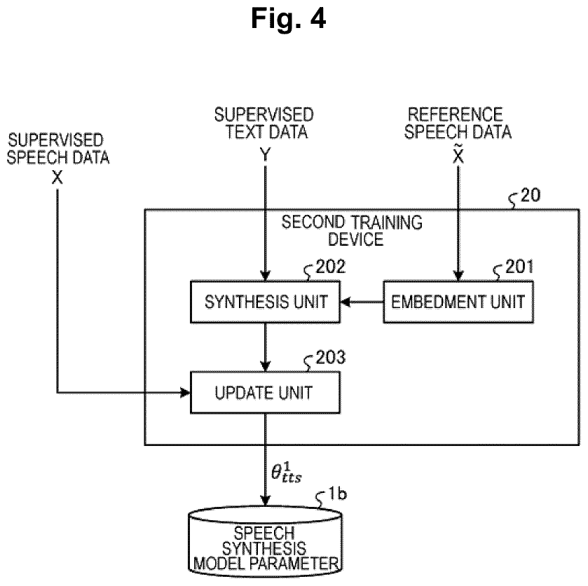

FIG. 4 is a diagram describing processing contents of the second training device. As illustrated in FIG. 4, the second training device 20 includes an embedment unit 201, a synthesis unit 202, and an update unit 203. The second training device 20 performs supervised learning of the speech synthesis model.

Supervised speech data X, supervised text data Y, and reference speech data ~X (~ immediately above X) are input to the second training device 20.

The reference speech data ~X is data indicating the characteristic of the speech uttered by the speaker, and is represented in the same format as the supervised speech data X. For example, the number of dimensions of each element of the supervised speech data X and the reference speech data ~X is equal. However, the number of elements (frame length) of the reference speech data ~X may be different from that of the supervised speech data X.

The embedment unit 201 acquires embedded data from the reference speech data ~X. The embedded data is a vector in which one or more dimensions are set in advance manually or the like. Each element of the embedded data takes a continuous value.

The embedment unit 201 can convert the reference speech data into embedded data by an arbitrary function such as a recurrent neural network. The embedment unit 201 calculates embedded data ~s as in Formula (6).

$$\begin{matrix}[ Math . 6 ] & \\ \tilde{s} = SpeakerModel ( \tilde{X} ; {θ}_{speaker} ) & ( 6 )\end{matrix}$$

However, SpeakerModel (⋅) is a trained model for acquiring the embedded data. In addition, θₛₚₑₐₖₑᵣ is a parameter of SpeakerModel (⋅). Note that, in the present embodiment, the parameter θₛₚₑₐₖₑᵣ is not updated.

The synthesis unit 202 inputs the supervised text data and the embedded data to the speech synthesis model and causes the speech synthesis model to output the synthesized speech data. For example, the speech synthesis model outputs synthesized speech data on the basis of a method called “FastSpeech 2” (see, for example, Reference Literature 2), which is a transformer-type neural network.

Reference Literature 2; Y. Ren, C. Hu, X. Tan, T. Qin, S. Zhao, Z. Zhao, and T. Liu, “FastSpeech 2: Fast and high-quality end-to-end text to speech,” in Proc. ICLR, 2021.

The speech synthesis model outputs synthesized speech data \hat{ }X (\hat{ }immediately above X) by Formulae (7), (8), (9), and (10).

$$\begin{matrix}[ Math . 7 ] & \\ U = FastSpeech 2 Enc ( y ; {θ}_{tts}^{enc} ) & ( 7 )\end{matrix}$$

$$\begin{matrix}[ Math . 8 ] & \\ V , \hat{p} , \hat{e} , \hat{d} = VarianceAdaptor ( U , \tilde{s} ; {θ}_{tts}^{va} ) & ( 8 )\end{matrix}$$

$$\begin{matrix}[ Math . 9 ] & \\ {\hat{X}}_{D} = FastSpeech 2 Dec ( V ; {θ}_{tts}^{dec} ) & ( 9 )\end{matrix}$$

$$\begin{matrix}[ Math . 10 ] & \\ \hat{X} = PostNet ( {\hat{X}}_{D} ; {θ}_{tts}^{post} ) & ( 10 )\end{matrix}$$

However, FastSpeech2Enc (⋅) is a portion corresponding to the encoder of the speech synthesis model. However, the encoder includes a self-attention mechanism. θ^{enc}ₜₜₛ is a parameter of the encoder of the speech synthesis model.

VarianceAdaptor (⋅) is a part of the speech synthesis model, and is a portion that extracts a parameter representing a speaker's characteristic from the embedded data. VarianceAdaptor (⋅) extracts parameters related to pitch (p), energy (e) and duration (d) of a speech. θ^{va}ₜₜₛ is a parameter of VarianceAdaptor (⋅).

In addition, FastSpeech2Dec (⋅) is a part of the speech synthesis model and is a portion corresponding to the decoder of the speech synthesis model. However, the decoder includes a self-attention mechanism. θ^{dec}ₜₜₛ is a parameter of the decoder of the speech synthesis model.

In the decoder, the parameter extracted by VarianceAdaptor (⋅) is used. As a result, the synthesized speech data is adapted to the speaker.

In addition, PostNet (⋅) is a portion that further converts the output from the decoder in the speech synthesis model. θ^{post}ₜₜₛ is a parameter of PostNet (⋅).

In addition, Θₜₜₛ is a combination of θ^{enc}ₜₜₛ, θ^{va}ₜₜₛ, θ^{dec}ₜₜₛ, and θ^{post}ₜₜₛ. The update unit 203 updates θₜₜₛ so that an error function Lus of Formula (11) is minimized. For example, the update unit 203 updates the parameter of the neural network by backpropagation. ∥⋅∥₁ is the L1-norm. ∥⋅∥₂ is the L2-norm. Note that p, e, and d without \hat{ } mean correct answer data of each predetermined parameter.

$$\begin{matrix}[ Math . 11 ] & \\ {L}_{TTS} = {‖ x - \hat{x} ‖}_{1} + {‖ x - {\hat{x}}_{D} ‖}_{1} + {‖ p - \hat{p} ‖}_{2}^{2} + {‖ e - \hat{e} ‖}_{2}^{2} + {‖ d - \hat{d} ‖}_{2}^{2} & ( 11 )\end{matrix}$$

The second training device 20 outputs the updated parameter as a speech synthesis model parameter 1b.

### [Third Training Device]

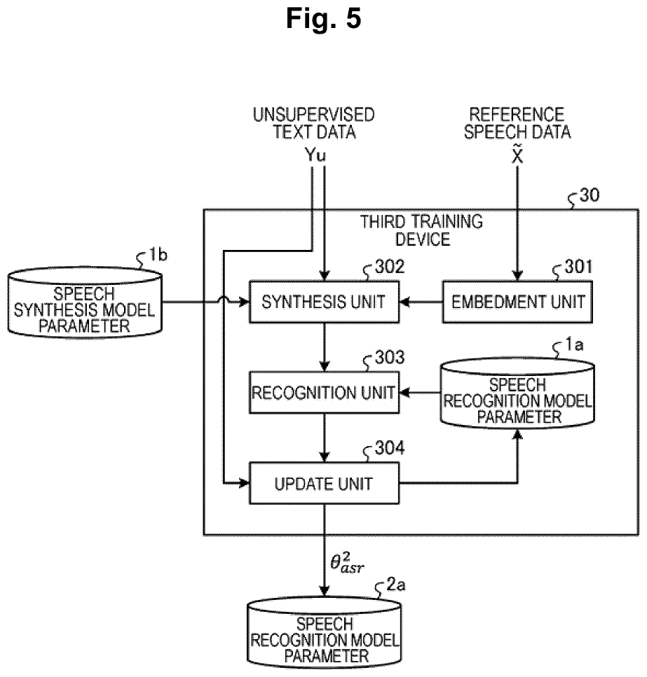

FIG. 5 is a diagram describing processing contents of the third training device. As illustrated in FIG. 5, the third training device 30 includes an embedment unit 301, a synthesis unit 302, a recognition unit 303, and an update unit 304. The third training device 30 performs semi-supervised learning of the speech recognition model.

Unsupervised text data Yu and reference speech data ~X are input to the third training device 30. In addition, in the third training device 30, a model is constructed with reference to the speech recognition model parameter 1a and the speech synthesis model parameter 1b.

In addition, the third training device 30 updates the speech recognition model parameter 1a and outputs the updated speech recognition model parameter as a speech recognition model parameter 2a. On the other hand, the third training device 30 does not update the speech synthesis model parameter 1b.

The embedment unit 301 acquires embedded data from the reference speech data ~X similarly to the embedment unit 201.

Similarly to the synthesis unit 202, the synthesis unit 302 inputs the text data and the embedded data to the speech synthesis model and causes the speech synthesis model to output the synthesized speech data. However, unlike the synthesis unit 202, the synthesis unit 302 inputs the supervised text data to the speech synthesis model.

Similarly to the recognition unit 101, the recognition unit 303 inputs the speech data to the speech recognition model and causes the speech recognition model to output text data. However, unlike the recognition unit 101, the recognition unit 303 inputs the synthesized speech data output by the synthesis unit 302 to the speech recognition model.

The update unit 304 updates Θₐₛᵣ such that an error function (cross entropy) L_{cycle} of Formula (12) is minimized. In this case, the update unit 304 updates the speech recognition model parameter 1a to the speech recognition model parameter 2a.

$$\begin{matrix}[ Math . 12 ] & \\ {L}_{cycle} = - \frac{1}{L} {\sum }_{l} log P ( {y}_{l} \vert {y}_{1 : l - 1} , \hat{X} ; {Θ}_{asr} ) & ( 12 )\end{matrix}$$

The supervised speech data X is used in Formula (5), whereas the synthesized speech data \hat{ }X is used in Formula (12).

Note that the embedment unit 301 and the synthesis unit 302 obtain the synthesized speech data \hat{ }X from the reference speech data ~X and the unsupervised text data Yu (y in Formula (13)) as in Formula (13). However, TTS(⋅) is a combination of a model for acquiring embedded data and a speech synthesis model, and corresponds to a combination of Formulae (6), (7), (8), (9), and (10).

$$\begin{matrix}[ Math . 13 ] & \\ \hat{X} = TTS ( y , \tilde{X} ; {Θ}_{tts} ) & ( 13 )\end{matrix}$$

The third training device 30 outputs the updated parameter as the speech recognition model parameter 2a.

### [Fourth Training Device]

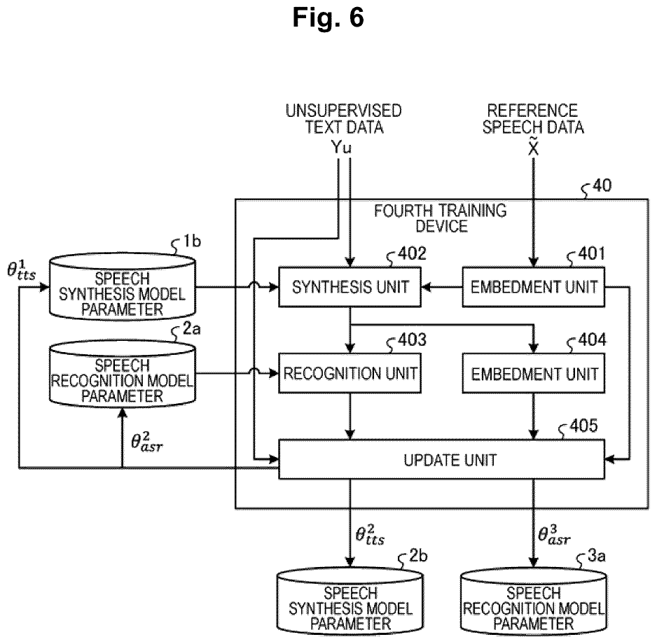

FIG. 6 is a diagram describing processing contents of the fourth training device. As illustrated in FIG. 6, the fourth training device 40 includes an embedment unit 401, a synthesis unit 402, a recognition unit 403, an embedment unit 404, and an update unit 405. The fourth training device 40 performs semi-supervised learning of the speech recognition model and the speech synthesis model.

Unsupervised text data Yu and reference speech data ~X are input to the fourth training device 40. In addition, in the fourth training device 40, a model is constructed with reference to the speech recognition model parameter 2a and the speech synthesis model parameter 1b.

In addition, the fourth training device 40 updates the speech recognition model parameter 2a and outputs the updated speech recognition model parameter as a speech recognition model parameter 3a. In addition, the fourth training device 40 updates the speech synthesis model parameter 1b and outputs the updated speech synthesis model parameter as a speech synthesis model parameter 2b.

The embedment unit 401 acquires embedded data ~s from the reference speech data ~X similarly to the embedment unit 301.

Similarly to the synthesis unit 302, the synthesis unit 402 inputs the unsupervised text data Yu and the embedded data ~X to the speech synthesis model and causes the speech synthesis model to output the synthesized speech data.

Similarly to the recognition unit 303, the recognition unit 403 inputs the synthesized speech data output by the synthesis unit 402 to the speech recognition model and causes the speech recognition model to output text data. The text data obtained at this time is referred to as reconstructed text data.

The embedment unit 404 acquires embedded data \hat{ }s from the synthesized speech data \hat{ }X output by the synthesis unit 402 as expressed by Formula (14).

$$\begin{matrix}[ Math . 14 ] & \\ \hat{s} = SpeakerModel ( \hat{X} ; {θ}_{speaker} ) & ( 14 )\end{matrix}$$

The update unit 405 updates the speech synthesis model parameter 1b and the speech recognition model parameter 2a. At that time, the update unit 405 creates an error function L_{SC} related to the speech synthesis model as indicated in Formula (15).

$$\begin{matrix}[ Math . 15 ] & \\ {L}_{SC} = \frac{{\hat{s}}^{T} \tilde{s}}{{‖ \hat{s} ‖}_{2} {‖ \tilde{s} ‖}_{2}} & ( 15 )\end{matrix}$$

The error function L_{SC} decreases as the embedded data ~s acquired by the embedment unit 401 and the embedded data \hat{ }s acquired by the embedment unit 404 are similar to each other. The error function L_{SC} increases as the embedded data ~s and the embedded data \hat{ }s deviate from each other.

As described above, the error function L_{SC} represents consistency of speaker individuality before and after the speech synthesis. Note that Reference Literature 3 describes that cosine similarity is used for a role of preserving speaker individuality when a speech synthesis model is trained alone. In addition, the error function L_{SC} is not limited to the cosine similarity, and it is sufficient if it is defined by an arbitrary index representing similarity between data such as a distance Euclidean distance.

Reference Literature 3: Z. Cai, C. Zhang, and M. Li, “From speaker verification to multispeaker speech synthesis, deep transfer with feedback constraint,” in Proc, INTERSPEECH, 2020, pp. 3974-3978.

Further, as indicated in Formula (16), the update unit 405 creates an error function Lₚᵣₒₚ from the error function L_{cycle} (Formula (12)) and the error function L_{SC} (Formula (15)). α is an arbitrarily determined weight.

$$\begin{matrix}[ Math . 16 ] & \\ {L}_{prop} = {L}_{cycle} + α {L}_{SC} & ( 16 )\end{matrix}$$

The update unit 405 updates Θₐₛᵣ and Θₜₜₛ so that the error function Lₚᵣₒₚ of Formula (16) is minimized. In this case, the update unit 405 updates the speech recognition model parameter 2a to the speech recognition model parameter 3a. In addition, the update unit 405 updates the speech synthesis model parameter 1b to the speech synthesis model parameter 2b.

In addition, the error function L_{SC} is obtained by adding a minus sign to the cosine similarity between the embedded data ~s and the embedded data \hat{ }s, both of which are vectors. Thus, the update unit 405 can update the parameters of the speech synthesis model and the parameters of the speech recognition model so that the cosine similarity between the embedded data ~s that is a vector and the embedded data \hat{ }s that is a vector increases.

The fourth training device 40 outputs the updated parameters as the speech recognition model parameter 3a and the speech synthesis model parameter 2b.

The fourth training device 40 generates synthesized speech data (an example of data related to the synthesized speech) from the embedded data representing the characteristic of the utterance of the speaker and the unsupervised text data using the speech synthesis model. The fourth training device 40 generates text data (recognition result of the speech recognition model) from the synthesized speech data using the speech recognition model. The update unit 534 updates the parameters of the speech synthesis model and the parameters of the speech recognition model such that the embedded data (output of the embedment unit 401) used to generate the synthesized speech is similar to the embedded data (output of the embedment unit 404) indicating the characteristic of the utterance of the synthesized speech, and the unsupervised text data is similar to the text data generated from the synthesized speech.

In addition, assuming that the processing by the fourth training device 40 is the processing of the second stage, the processing by the third training device 30 corresponds to the processing of the first stage.

### [Processing in First Embodiment]

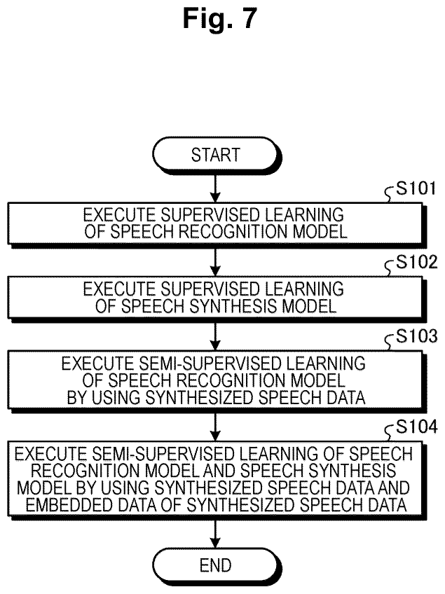

A flow of training processing of the first embodiment will be described with reference to FIG. 7. Here, it is assumed that the training device 5 executes each processing.

As illustrated in FIG. 7, first, the training device 5 executes the supervised learning of the speech recognition model (step S101). Next, the training device 5 executes the supervised learning of the speech synthesis model (step S102).

Steps S101 and S102 may be performed in advance by another device. In this case, the parameters of the updated speech recognition model and speech synthesis model are delivered to the training device 5.

Subsequently, the training device 5 executes the semi-supervised learning of the speech recognition model by using the synthesized speech data (step S103). Here, the training device 5 can obtain the synthesized speech data from the unsupervised text data by using the speech synthesis model trained in step S102.

In addition, in step S103, the training device 5 may simultaneously perform the supervised learning of the speech recognition model by using a smaller amount of supervised speech data and supervised text data than unsupervised text data.

Then, the training device 5 executes the semi-supervised learning of the speech recognition model and the speech synthesis model by using the synthesized speech data and the embedded data of the synthesized speech data (step S104). Here, the training device 5 can obtain the synthesized speech data from the unsupervised text data by using the speech synthesis model trained in step S102. In addition, the training device 5 can obtain a recognition result (reconstructed text data) of the synthesized speech data by using the speech recognition model trained in step S103.

In addition, in step S104, the training device 5 may simultaneously perform the supervised learning of the speech recognition model and the speech synthesis model by using a smaller amount of supervised speech data and supervised text data than unsupervised text data.

As described above, in step S103, the training device 5 performs training only for the speech recognition model by using the collaborative learning method after fixing the speech synthesis model. Then, in step S104, the training device 5 releases the fixation of the speech synthesis model and performs training for both the speech recognition model and the speech synthesis model by using the collaborative learning method.

### [Inference Phase]

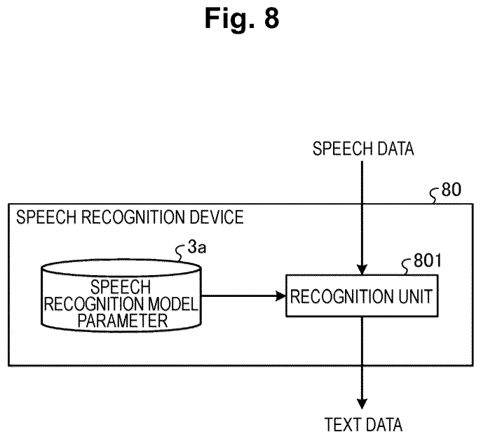

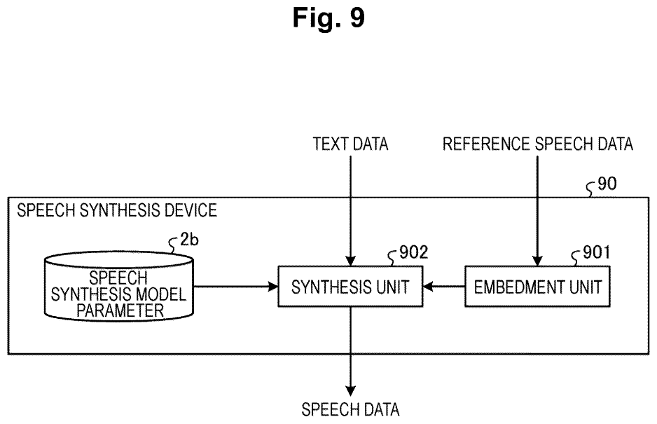

The training phases of the speech recognition model and the speech synthesis model have been described. Each trained model is actually used in an inference phase according to the aspects illustrated in FIGS. 8 and 9. FIG. 8 is a diagram describing processing contents of a speech recognition device. FIG. 9 is a diagram describing processing contents of a speech synthesis device.

As illustrated in FIG. 8, a speech recognition device 80 includes a recognition unit 801. The recognition unit 801 generates text data from a speech model by using the speech recognition model constructed from the speech recognition model parameter 3a. The speech recognition model parameter 3a has been updated by the fourth training device 40. In addition, the text data to be paired with the speech data may be unknown.

As illustrated in FIG. 9, a speech synthesis device 90 includes an embedment unit 901 and a synthesis unit 902. The embedment unit 901 acquires embedded data from the reference speech data. The synthesis unit 902 generates speech data from the embedded data and the text data by using the speech synthesis model parameter 2b. The speech synthesis model parameter 2b has been updated by the fourth training device 40. In addition, the speech data to be paired with the text data may be unknown.

The reference speech data input to the speech synthesis device 90 and the embedded data acquired from the reference speech data may be the same as or different from the reference speech data and the embedded data at the time of training, that is, the reference speech data and the embedded data (output of the embedment unit) illustrated in FIGS. 4, 5, and 6.

Note that the speech recognition device 80 and the speech synthesis device 90 may be achieved as one function of the training device 5 or may be achieved as independent devices.

### [Effects of First Embodiment]

An effect of the first embodiment will be described assuming that the training device 5 performs the training processing described above. Note that, even in a case where the functions of the training device 5 are distributed to the first training device 10, the second training device 20, the third training device 30, and the fourth training device 40, a similar effect can be obtained.

As described above, the synthesis unit 532 generates data regarding the synthesized speech from first embedded data representing the characteristic of the utterance of the speaker and first text data by using a first model. The recognition unit 533 generates second text data from the data related to the synthesized speech by using a second model. The update unit 534 updates the parameters of the first model and the parameters of the second model such that the first embedded data is similar to second embedded data representing the characteristic of the utterance of the synthesized speech, and the first text data is similar to the second text data. Note that this configuration corresponds to the fourth training device 40.

As described above, the training device 5 updates the parameters of both the speech recognition model (second model) and the speech synthesis model (first model) so that the speaker's characteristic (first embedded data) obtained from the reference speech data becomes close to the characteristic (second embedded data) of the utterance obtained from the synthesized speech data. As a result, it is possible to prevent the speech synthesis model from synthesizing an unnatural speech that is easily recognized by the speech recognition model, and to improve the quality of the synthesized speech.

In addition, in the first stage, the synthesis unit 532 generates data regarding the synthesized speech from third embedded data representing the characteristic of the utterance of the speaker and third text data by using the first model. In the first stage, the recognition unit 533 generates fourth text data from the data related to the synthesized speech by using the second model. In the first stage, the update unit 534 updates the parameters of the first model so that the third text data and the fourth text data are similar to each other. In a second stage after the first stage, the synthesis unit 532 generates data regarding the synthesized speech from the first embedded data representing the characteristic of the utterance of the speaker and the first text data by using the first model whose parameters have been updated in the first stage. In the second stage, the recognition unit 533 generates the second text data from the data related to the synthesized speech by using the second model. In the second stage, the update unit 534 updates the parameters of the first model and the parameters of the second model such that the first embedded data is similar to second embedded data representing the characteristic of the utterance of the synthesized speech, and the first text data is similar to the second text data. Note that the configuration of the first stage corresponds to the third training device 30. In addition, the configuration of the second stage corresponds to the fourth training device 40.

As described above, by fixing the speech synthesis model in the first stage and performing training only for the speech recognition model, it is possible to suppress a decrease in accuracy of the speech recognition model and over-training of the speech synthesis model.

Note that, from both the third training device 30 and the fourth training device 40, effects such as improvement in quality of the synthesized speech and suppression of over-training of the speech synthesis model can be obtained by a certain amount.

The update unit 534 updates the parameters of the first model and the parameters of the second model such that the similarity between the first embedded data that is a vector and the second embedded data that is a vector increases.

As a result, it is possible to cause the speech synthesis model to retain speaker individuality (characteristic of the utterance of the speaker). Note that it is sufficient if the similarity is an index indicating closeness between data (between vectors), and the similarity is not limited to the cosine similarity, but may be a Euclidean distance or the like.

The present embodiment can be used to generate a speech synthesis model that generates a synthesized speech of natural spoken words or dialects. In this case, for example, unsupervised text data described in spoken words or dialects is used.

In addition, the present embodiment is likely to produce an effect in multi-speaker speech synthesis that is particularly likely to deteriorate in quality, but since embedded data is also used in single-speaker speech synthesis, a certain amount of effect is produced.

In addition, the synthesis unit 532 generates data regarding the synthesized speech from fourth embedded data representing the characteristic of the utterance of the speaker and fifth text data by using the first model whose parameters have been updated by the update unit 534.

As described above, by using the speech synthesis model trained according to the present embodiment, it is possible to actually obtain a high-quality synthesized speech in the inference phase.

The training device according to the first embodiment provides a specific improvement with respect to the conventional machine learning method as described in Non Patent Literature 1, and indicates improvement in the technical field related to speech recognition and speech synthesis by a machine learning model.

### Second Embodiment

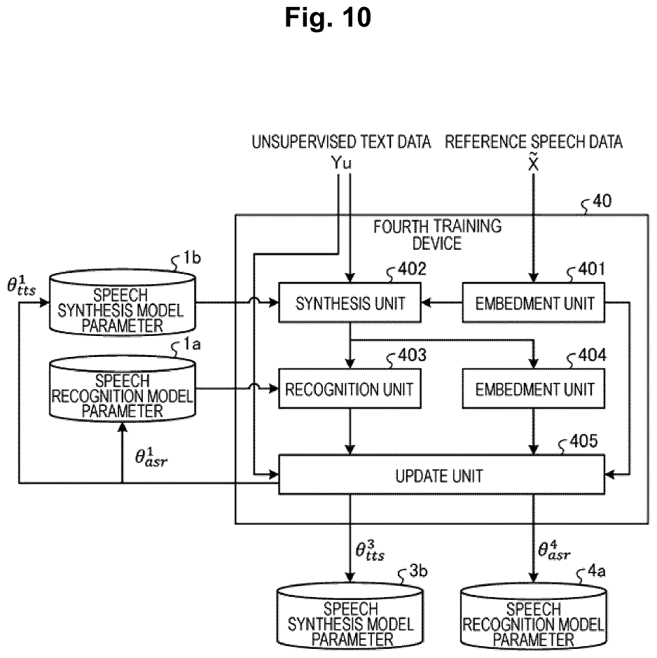

FIG. 10 is a diagram describing processing contents of a fourth training device according to the second embodiment. In the second embodiment, processing by the third training device 30 is omitted.

In the example of FIG. 6, the fourth training device 40 constructs the speech recognition model from the speech recognition model parameter 2a, whereas in the example of FIG. 10, a speech recognition model is constructed from a speech recognition model parameter 1a.

In the second embodiment, a fourth training device 40 receives the speech recognition model parameter 1a from a first training device 10.

Then, the fourth training device 40 outputs a speech recognition model parameter 4a obtained by updating the speech recognition model parameter 1a and a speech synthesis model parameter 3b obtained by updating a speech synthesis model parameter 1b.

In the second embodiment, the quality of the synthesized speech can be improved with a simple configuration.

The training device according to the second embodiment provides a specific improvement with respect to the conventional machine learning method as described in Non Patent Literature 1, and indicates improvement in the technical field related to speech recognition and speech synthesis by a machine learning model.

### Third Embodiment

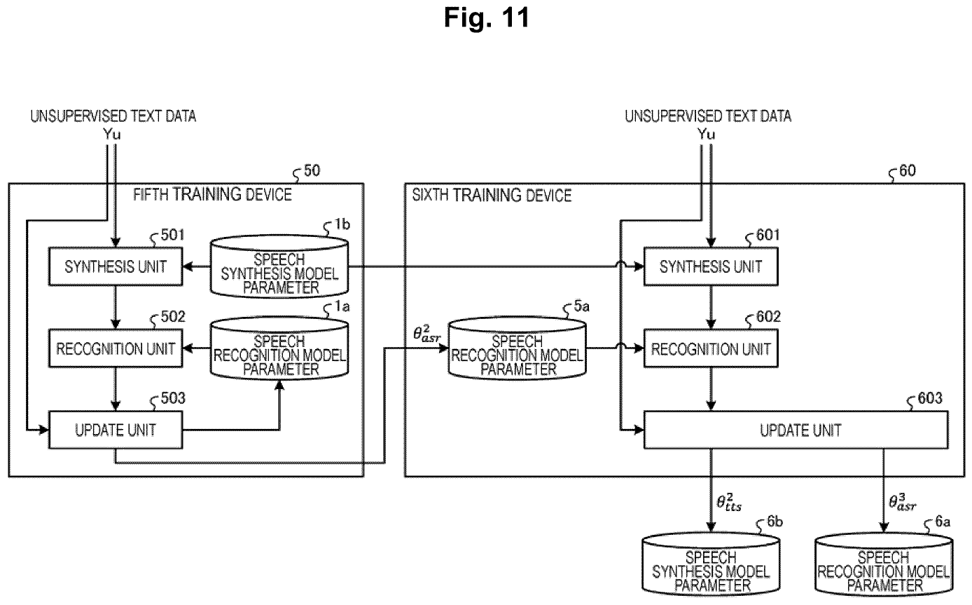

FIG. 11 is a diagram describing processing contents of a fifth training device and a sixth training device according to the third embodiment. In the third embodiment, processing by the fourth training device 40 is omitted, and processing equivalent to that of the third training device 30 is achieved by two-stage training by a fifth training device 50 and a sixth training device 60. In addition, in the third embodiment, the reference speech data and the embedded data are not used.

As illustrated in FIG. 11, the fifth training device 50 includes a synthesis unit 501, a recognition unit 502, and an update unit 503. In addition, the sixth training device 60 includes a synthesis unit 601, a recognition unit 602, and an update unit 603.

The fifth training device 50 constructs a speech recognition model from a speech recognition model parameter 1a and constructs a speech synthesis model from a speech synthesis model parameter 1b. The fifth training device 50 delivers a speech recognition model parameter 5a obtained by updating the speech recognition model parameter 1a to the sixth training device 60.

The fifth training device 50 does not update the speech synthesis model parameter 1b. As a result, as in the first embodiment, an effect by stepwise training can be obtained.

The sixth training device 60 constructs a speech recognition model from the speech recognition model parameter 5a and constructs a speech synthesis model from the speech synthesis model parameter 1b. The sixth training device 60 outputs a speech recognition model parameter 6a obtained by updating the speech recognition model parameter 5a and a speech synthesis model parameter 6b obtained by updating the speech synthesis model parameter 1b.

In the third embodiment, it is possible to suppress over-training of the speech synthesis model with a simple configuration that does not require embedded data.

The training device according to the third embodiment provides a specific improvement with respect to the conventional machine learning method as described in Non Patent Literature 1, and indicates improvement in the technical field related to speech recognition and speech synthesis by a machine learning model.

### Experiment

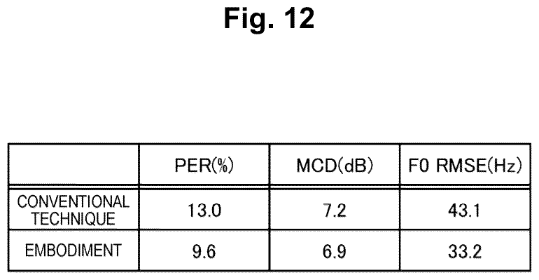

In FIG. 12, a result of an experiment for comparing the embodiment with the conventional technique is illustrated in FIG. 12, FIG. 12 is a diagram illustrating experimental results.

The conventional technique in FIG. 12 is a method of updating the parameters of the speech recognition model on the basis of the error function L_{CE} indicated in Formula (5) by supervised learning, updating the parameters of the speech synthesis model on the basis of the error function L_{TTS} indicated in Formula (11) by supervised learning, and updating the parameters of both the speech recognition model and the speech synthesis model on the basis of the error function L_{cycle} indicated in Formula (12) by semi-supervised learning.

The embodiment in FIG. 12 is a method of updating the parameters of the speech recognition model on the basis of the error function L_{CE} indicated in Formula (5) by supervised learning, updating the parameters of the speech synthesis model on the basis of the error function L_{TTS} indicated in Formula (11) by supervised learning, and updating the parameters of both the speech recognition model and the speech synthesis model on the basis of the error function Lₚᵣₒₚ indicated in Formula (16) by semi-supervised learning.

The data used in the experiment are as described below.
Supervised data: “train-clean-100” set of LibriTTS dataset
Unsupervised data: “train-clean-360” set of LibriTTS dataset
Evaluation data: “dev-clean” set and “test-clean-100” set of LibriTTS dataset

In addition, a “dev” set of VoxCeleb2 dataset was used for preliminary training of a model for acquiring the embedded data.

VoxCeleb2 is described in Reference Literature 4. In addition, LibriTTS is described in Reference Literature 5.
Reference Literature 4: J. S. Chung, A. Nagrani, and A. Zisserman, “VoxCeleb2: Deep speaker recognition,” in Proc. INTERSPEECH, 2018, pp. 1086-1090.
Reference Literature 5: H. Zen, V. Dang, R. Clark, Y. Zhang, R. J. Weiss, Y. Jia, Z. Chen, and Y. Wu, “LibriTTS: A corpus derived from librispeech for text-to-speech,” in Proc. INTERSPEECH, 2019, pp. 1526-1530.

As illustrated in FIG. 12, the comparison between the embodiment and the conventional technique was performed using three indices of phoneme error rate (PER), mel-cepstral distortion (MCD), and F0 root mean square error of fundamental frequency (RMSE).

PER is an index indicating the accuracy of the speech recognition model, MCD and F0 RMSE are indices indicating the accuracy of the speech synthesis model. A smaller index means higher accuracy.

As illustrated in FIG. 12, in all of the PER, the MCD, and the F0 RMSE, better results were obtained in the embodiment than in the conventional technique.

In particular, regarding the MCD and the F0 RMSE, it is considered that the result of the embodiment is improved by considering the consistency of the speaker in the loss function. In addition, regarding PER, it is considered that the result of the embodiment is improved by stepwise parameter update.

### [System Configuration and the Like]

In addition, each of components of the illustrated devices is functionally conceptual, and does not necessarily need to be physically configured as illustrated. That is, a specific form of distribution and integration of the devices is not limited to the illustrated form, and can be configured by functionally or physically distributing or integrating all or some thereof in any unit depending on various loads, use status, and the like. Further, the whole or any part of processing functions performed in the devices can be implemented by a central processing unit (CPU) and a program analyzed and executed by the CPU, or can be implemented as hardware by wired logic. Note that the program may be executed not only by a CPU but also by another processor such as a GPU.

In addition, among the pieces of processing described in the present embodiment, all or some of the pieces of processing described as being automatically performed can be manually performed, or all or some of the pieces of processing described as being manually performed can be automatically performed by a known method. The processing procedures, control procedures, specific names, and information including various types of data and parameters described in the above literature and drawings can be arbitrarily changed unless otherwise mentioned.

### [Program]

As an embodiment, the training device 5 can be implemented by installing a training program for executing the above training processing as packaged software or online software in a desired computer. For example, an information processing device can be caused to function as the training device 5 by causing the information processing device to execute the above training program. The information processing device mentioned here includes a desktop or a laptop personal computer. In addition, the information processing device includes a mobile communication terminal such as a smartphone, a mobile phone or a personal handyphone system (PHS), as well as a slate terminal such as a personal digital assistant (PDA).

In addition, the training device 5 can also be implemented as a training server device that uses a terminal device used by the user as a client and provides the client with a service related to the training processing described above. For example, the training server device is mounted as a server device that provides a training service having training data as an input and parameters of a trained model as an output. In this case, the training server device may be implemented as a web server, or may be implemented as a cloud that provides a service related to the training processing by outsourcing.

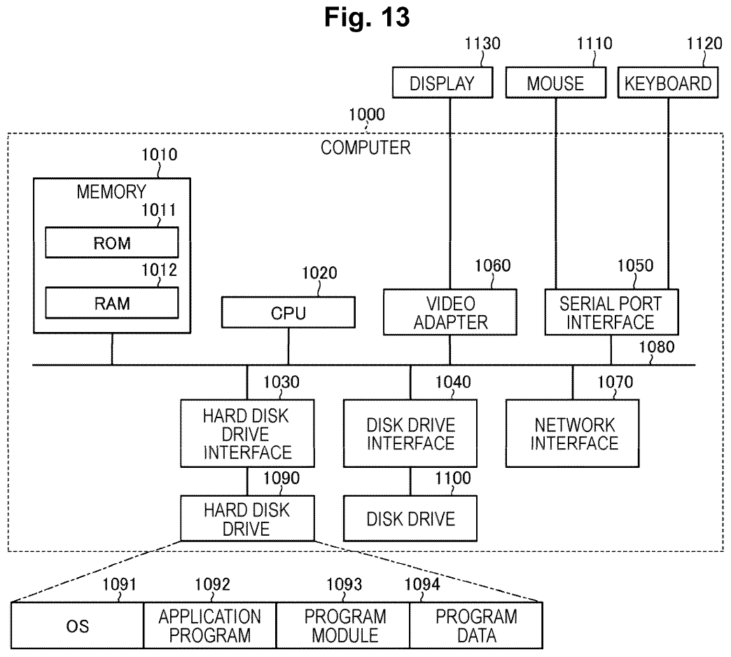

FIG. 13 is a diagram illustrating an example of a computer that executes the training program. A computer 1000 includes, for example, a memory 1010 and a CPU 1020. In addition, the computer 1000 also includes a hard disk drive interface 1030, a disk drive interface 1040, a serial port interface 1050, a video adapter 1060, and a network interface 1070. These units are connected to each other via a bus 1080.

The memory 1010 includes read only memory (ROM) 1011 and random access memory (RAM) 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, the program that defines each processing operation of the training device 5 is implemented as the program module 1093 in which codes executable by a computer are described. The program module 1093 is stored in, for example, the hard disk drive 1090. For example, the program module 1093 executing processing similar to the functional configuration in the training device 5 is stored in the hard disk drive 1090. Note that the hard disk drive 1090 may be replaced with a solid state drive (SSD).

In addition, setting data used in the processing in the embodiment described above is stored in, for example, the memory 1010 or the hard disk drive 1090 as the program data 1094. Then, the CPU 1020 reads the program module 1093 and the program data 1094 stored in the memory 1010 or the hard disk drive 1090 to the RAM 1012 as necessary and executes the processing of the embodiment described above.

Note that the program module 1093 and the program data 1094 are not limited to being stored in the hard disk drive 1090, and may be stored in, for example, a removable storage medium and read by the CPU 1020 via the disk drive 1100 or the like. Alternatively, the program module 1093 and the program data 1094 may be stored in another computer connected via a network (local area network (LAN), wide area network (WAN), or the like). Then, the program module 1093 and the program data 1094 may be read by the CPU 1020 from another computer via the network interface 1070.

Regarding the above embodiments, the following supplementary notes are further disclosed.

### (Supplementary Note 1)

A training device comprising:
a memory; and
at least one processor that is connected to the memory, in which
the processor
generates data related to a synthesized speech from first embedded data representing a characteristic of an utterance of a speaker and first text data by using a first model,
generates second text data from data related to the synthesized speech by using a second model, and
updates a parameter of the first model and a parameter of the second model such that the first embedded data is similar to second embedded data representing a characteristic of an utterance of the synthesized speech, and the first text data is similar to the second text data.

### (Supplementary Note 2)

A non-transitory storage medium storing a program executable by a computer to execute training processing, the training processing including:
generating data related to a synthesized speech from first embedded data representing a characteristic of an utterance of a speaker and first text data by using a first model;
generating second text data from data related to the synthesized speech by using a second model; and
updating a parameter of the first model and a parameter of the second model such that the first embedded data is similar to second embedded data representing a characteristic of an utterance of the synthesized speech, and the first text data is similar to the second text data.

### (Supplementary Note 3)

A training device including:
a memory; and
at least one processor that is connected to the memory, in which
the processor
in a first stage, generates data related to a synthesized speech from third embedded data representing a characteristic of an utterance of a speaker and third text data by using the first model,
in the first stage, generates fourth text data from data related to the synthesized speech by using the second model,
in the first stage, updates the parameter of the first model such that the third text data and the fourth text data are similar to each other,
in a second stage after the first stage, generates data related to a synthesized speech from the first embedded data representing the characteristic of the utterance of the speaker and the first text data by using the first model whose parameter has been updated in the first stage,
in the second stage, generates the second text data from data related to the synthesized speech by using the second model, and
in the second stage, updates the parameter of the first model and the parameter of the second model such that the first embedded data is similar to the second embedded data representing the characteristic of the utterance of the synthesized speech, and the first text data is similar to the second text data.

### (Supplementary Note 4)

A non-transitory storage medium storing a program executable by a computer to execute training processing, the training processing including:
in a first stage, generating data related to a synthesized speech from third embedded data representing a characteristic of an utterance of a speaker and third text data by using the first model,
in the first stage, generating fourth text data from data related to the synthesized speech by using the second model,
in the first stage, updating the parameter of the first model such that the third text data and the fourth text data are similar to each other,
in a second stage after the first stage, generating data related to a synthesized speech from the first embedded data representing the characteristic of the utterance of the speaker and the first text data by using the first model whose parameter has been updated in the first stage,
in the second stage, generating the second text data from data related to the synthesized speech by using the second model, and
in the second stage, updating the parameter of the first model and the parameter of the second model such that the first embedded data is similar to the second embedded data representing the characteristic of the utterance of the synthesized speech, and the first text data is similar to the second text data.

### (Supplementary Note 5)

The training device according to supplementary note 1, in which the processor
updates the parameter of the first model and the parameter of the second model such that similarity between the first embedded data that is a vector and the second embedded data that is a vector increases.

### (Supplementary Note 6)

The non-transitory storage medium according to supplementary note 2, in which the training processing includes
updating the parameter of the first model and the parameter of the second model such that similarity between the first embedded data that is a vector and the second embedded data that is a vector increases.

### (Supplementary Note 7)

The training device according to supplementary note 1, in which the processor
generates data regarding the synthesized speech from fourth embedded data representing the characteristic of the utterance of the speaker and fifth text data by using the first model whose parameter has been updated.

### (Supplementary Note 8)

The non-transitory storage medium according to supplementary note 2, in which the training processing includes
generating data regarding the synthesized speech from fourth embedded data representing the characteristic of the utterance of the speaker and fifth text data by using the first model whose parameter has been updated.

### (Supplementary Note 9)

A speech synthesis device including:
a synthesis unit that generates data related to a synthesized speech from fourth embedded data representing a characteristic of an utterance of a speaker and a fifth text data by using a first model whose parameter has been updated by processing of generating data related to a synthesized speech from first embedded data representing a characteristic of an utterance of a speaker and first text data by using the first model, generating second text data from data related to the synthesized speech by using a second model, and updating the parameter of the first model and a parameter of the second model such that the first embedded data is similar to second embedded data representing a characteristic of an utterance of the synthesized speech, and the first text data is similar to the second text data.

### (Supplementary Note 10)

A speech synthesis method executed by a speech synthesis device, the speech synthesis method including:
a synthesis process of generating data related to a synthesized speech from fourth embedded data representing a characteristic of an utterance of a speaker and a fifth text data by using a first model whose parameter has been updated by processing of generating data related to a synthesized speech from first embedded data representing a characteristic of an utterance of a speaker and first text data by using the first model, generating second text data from data related to the synthesized speech by using a second model, and updating the parameter of the first model and a parameter of the second model such that the first embedded data is similar to second embedded data representing a characteristic of an utterance of the synthesized speech, and the first text data is similar to the second text data,

### (Supplementary Note 11)

A speech synthesis method executed by a speech synthesis device, the speech synthesis method causing a computer to execute:
a synthesis step of generating data related to a synthesized speech from fourth embedded data representing a characteristic of an utterance of a speaker and a fifth text data by using a first model whose parameter has been updated by processing of generating data related to a synthesized speech from first embedded data representing a characteristic of an utterance of a speaker and first text data by using the first model, generating second text data from data related to the synthesized speech by using a second model, and updating the parameter of the first model and a parameter of the second model such that the first embedded data is similar to second embedded data representing a characteristic of an utterance of the synthesized speech, and the first text data is similar to the second text data.

### REFERENCE SIGNS LIST

5 Training device
51 Communication unit
52 Storage unit
53 Control unit
1a, 2a, 3a, 4a, 5a, 6a, 521 Speech recognition model parameter
1b, 2b, 3b, 6b, 522 Speech synthesis model parameter
201, 301, 401, 404, 531, 901 Embedment unit
202, 302, 402, 532, 902 Synthesis unit
101, 303, 403, 533, 801 Recognition unit
102, 203, 304, 405, 534 Update unit

1. A training apparatus comprising:
processing circuitry configured to:
generate data related to a synthesized speech from first embedded data representing a characteristic of an utterance of a speaker and first text data by using a first model;
generate second text data from data related to the synthesized speech by using a second model; and
update a parameter of the first model and a parameter of the second model such that the first embedded data is similar to second embedded data representing a characteristic of an utterance of the synthesized speech, and the first text data is similar to the second text data.

2. The training apparatus according to claim 1, wherein
the processing circuitry is further configured to generate, in a first stage, data related to a synthesized speech from third embedded data representing a characteristic of an utterance of a speaker and third text data by using the first model,
in the first stage, fourth text data from data related to the synthesized speech by using the second model,
update, in the first stage, the parameter of the first model such that the third text data and the fourth text data are similar to each other,
generate, in a second stage after the first stage, data related to a synthesized speech from the first embedded data representing the characteristic of the utterance of the speaker and the first text data by using the first model whose parameter has been updated in the first stage,
generate, in the second stage, the second text data from data related to the synthesized speech by using the second model, and
update, in the second stage, the parameter of the first model and the parameter of the second model such that the first embedded data is similar to the second embedded data representing the characteristic of the utterance of the synthesized speech, and the first text data is similar to the second text data.

3. The training apparatus according to claim 1, wherein the processing circuitry is further configured to update the parameter of the first model and the parameter of the second model such that similarity between the first embedded data that is a vector and the second embedded data that is a vector increases.

4. A training method executed by a training apparatus, the training method comprising:
generating data related to a synthesized speech from first embedded data representing a characteristic of an utterance of a speaker and first text data by using a first model;
generating second text data from data related to the synthesized speech by using a second model; and
updating a parameter of the first model and a parameter of the second model such that the first embedded data is similar to second embedded data representing a characteristic of an utterance of the synthesized speech, and the first text data is similar to the second text data.

5. A non-transitory computer-readable recording medium storing therein a training program that causes a computer to execute a process comprising:
generating data related to a synthesized speech from first embedded data representing a characteristic of an utterance of a speaker and first text data by using a first model;
generating second text data from data related to the synthesized speech by using a second model; and
updating a parameter of the first model and a parameter of the second model such that the first embedded data is similar to second embedded data representing a characteristic of an utterance of the synthesized speech, and the first text data is similar to the second text data.

6. A speech synthesis apparatus comprising:
processing circuitry configured to:
generate data related to a synthesized speech from third embedded data representing a characteristic of an utterance of a speaker and a third text data by using a first model whose parameter has been updated by processing of generating data related to a synthesized speech from first embedded data representing a characteristic of an utterance of a speaker and first text data by using the first model, generating second text data from data related to the synthesized speech by using a second model, and updating the parameter of the first model and a parameter of the second model such that the first embedded data is similar to second embedded data representing a characteristic of an utterance of the synthesized speech, and the first text data is similar to the second text data.
